(19) United States
(12) Patent Application Publication
(10) Pub. No.: US 2003/0165110 A1
(43) Pub. Date: Sep. 4, 2003

(54) Write-once high density optical storage medium and process for fabricating the same

(75) Inventors: Shyhyeu Wang, Hsin Chu (TW); Chun-Han Wu, Hsin Chu (TW)

Correspondence Address: QUINTERO LAW OFFICE, 1617 BROADWAY, 3RD FLOOR, SANTA MONICA, CA, 90404, US

(73) Assignee: Ritek Corporation

(21) Appl. No.: 10/355,966

(22) Filed: Jan. 31, 2003

(30) Foreign Application Priority Data
Mar. 4, 2002 (TW) 91103933

(51) Int. Cl. G11B 7/24

(52) U.S. Cl. 369/275.5; 369/288; 369/121

(57) ABSTRACT

A write-once high density optical storage medium. The optical storage medium is applicable in an optical read or write system with blue laser having a wavelength in between 385 nm to 425 nm and an objective lens with numerical aperture (NA) greater than 0.8 and includes the following film structure: a substrate; a reflective layer disposed on the substrate; a dye recording layer disposed on the reflective layer; a protective layer disposed on the dye recording layer; and a cover layer disposed on the protective layer. The protective layer prevents direct contact between the dye recording layer and cover layer, thus assuring the medium quality.

### BACKGROUND OF THE INVENTION

1. Field of the Invention

The present invention relates to a high density optical storage medium and process for fabrication thereof, and more particularly to a high quality write-once high density optical storage medium.

2. Description of the Prior Art

Since compact discs (CD) were developed in the early 1980s, many researchers have been increasingly trying to develop optical discs with higher capacity and higher quality. For example, the second generation optical disc, DVD (digital versatile disc), was developed in 1997. DVD uses a laser beam having a wavelength about 650 nm and has a storage capacity increased from hundreds of MB (megabytes) for CD to several GB (gigabytes). For example, the single side DVD5 has a storage capacity of 4.7 GB and the capacity of double side double layer DVD18 reaches about 18 GE. However, even higher capacity is required for applications like digital broadcasting recording and wide screen HD-TV. Therefore, high density optical storage media using blue laser has been developed.

Generally, such new generation high density optical storage system (high density DVD; HD-DVD) uses a laser beam having a wavelength of 405 nm (compared to 650 nm for DVD) and an objective lens with numerical aperture (NA) greater than 0.8 for recording and reading. Thus, the storage capacity of HD-DVD medium can increase to 50 GB.

However, the fabrication method of the HD-DVD recordable (HD-DVD-R) medium differs greatly from conventional CD or DVD recordable medium. Particularly, when an organic dye is used as the recording layer, the HD-DVD-R will have the same film structure but different sequence of forming the films from conventional CD-R or DVD-R medium. The substrate thickness for a CD-R medium is 1.2 mm. For DVD-R, it is 0.6 mm. And for HD-DVD-R media, it is 1.1 mm. While, the reading and writing for HD-DVD-R is different from conventional CD-R or DVD-R. For CD-R and DVD-R, the reading and writing laser passes through the substrate. On the other hand, the reading and writing laser for HD-DVD-R passes through the cover layer on the opposite side of the substrate. The cover layer has a thickness of 0.05 mm to 0.2 mm (50 μm to 200 μm),

Because of the above-mentioned differences, the sequence of forming film structure of a HD-DVD-R medium must be different from the conventional CD-R and DVD-R media.

FIG. 1 is a cross-section illustrating the film structure of conventional CD-R or DVD-R media. A dye recording layer 12, a metal reflective layer 13, and a lacquer layer 14 are successively formed on a substrate 11 The reading and writing surface is on the substrate surface and the reading direction is depicted by the arrow A. However, for the HD-DVD-R medium, the reading surface is the surface of the cover layer which is the opposite surface of the substrate. That is, the laser irradiates on the surface of the cover layer 24 (thickness is only about 0.1 mm) and the reading direction is depicted by the arrow B as shown in FIG. 2. Therefore, the sequence of the film construction must be adjusted. Referring to FIG. 2, a metal reflective layer 23, a dye recording layer 22, and a cover layer 24 are successively formed on a substrate 21 (thickness is about 1.1 mm for a single side disc). Since the dye recording layer 22 is formed after the reflective layer 23, contrary to the conventional CD-R and DVD-R media, the dye recording layer 22 is inevitably in direct contact with the cover layer 24. Consequently, when forming the cover layer 24, the dye recording layer 22 will be damaged, in turn adversely affecting the disc quality.

Generally, the cover layer 24 can be formed by first spin coating or screen printing a photosensitive lacquer and then by curing the lacquer with UV irradiation to harden the lacquer. The difficulty resides in that before curing, the lacquer will easily damage the dye recording layer 22, due to the possibility for the solvent-like lacquer to dissolve the dye.

FIGS. 3a and 3b are cross-sections illustrating other film structures of a high density optical storage disc, in which an adhesive is used. Referring to FIG. 3a, an adhesive is coated on the above-mentioned dye recording layer 22 to form an adhesive layer 31. Next, a transparent film 32 is applied to adhere to the adhesive layer 31 to form the cover layer. Or, alternatively, referring to FIG. 3b, a film 321 already having a pressure sensitive adhesive 311 thereon is bonded onto the dye recording layer 22. However, either the adhesive layer 31 or the pressure sensitive adhesive 311 has the possibility of damaging the dye or changing the property of dye recording layer 22. Consequently, the dye recording layer 22 will be damaged and disc quality will not be accepted.

### SUMMARY OF THE INVENTION

An object of the present invention is to solve the above-mentioned problems and provide a high density write-once optical storage medium (HD-DVD-R) without quality problems caused by the interaction of the dye recording layer and cover layer.

To achieve the above objects, the HD-DVD-R medium of the present invention which is applicable in an optical reading or writing system with laser having a wavelength of 385 nm to 425 nm and objective lens with numerical aperture (NA) greater than 0.8 includes the following film structure: a substrate; a reflective layer disposed on the substrate; a dye recording layer disposed on the reflective layer; a protective layer disposed on the dye recording layer; and a cover layer disposed on the protective layer. The cover layer has a thickness of 50 μm to 200 μm.

The aspect of the present invention as that the protective layer is disposed on the dye recording layer. This prevents the cover layer from contacting the dye recording layer, so that disc quality is not adversely affected. In addition, when forming the cover layer, the dye recording layer is protected by the protective layer and is not easily damaged, thus ensuring disc quality.

According to the present invention, the protective layer is formed by sputtering of an inorganic material, preferably an inorganic material having high transparency to the laser used in the HD-DVD-R optical system.

The present invention also provides a process for fabricating a write-once high density optical storage medium. The process includes the following steps. First, a reflective layer is formed on a substrate by sputtering. Next, a dye recording layer is formed on the reflective layer by spin coating or vacuum evaporation. Next, a protective layer is formed on the dye recording layer by sputtering. Finally, a cover layer is formed on the protective layer by spin coating or adhering.

### BRIEF DESCRIPTION OF THE DRAWINGS

The present invention will become more fully understood from the detailed description given hereinbelow and the accompanying drawings, given by way of illustration only and thus not intended to be a limitation of the present invention.

FIG. 1 is a cross-section illustrating the film structure of a conventional optical disc.

FIG. 2 is a cross-section illustrating the film structure of a high density write-once optical storage medium (HD-DVD-R).

FIGS. 3a and 3b are cross-sections illustrating other film structures of high density write-once optical storage medium (HD-DVD-R), in which an adhesive is used.

FIG. 4 is a cross-section of the high density write-once optical storage medium (HD-DVD-R) according to a first preferred embodiment of the present invention.

FIGS. 5a and 5b are cross-sections of the high write-once optical storage medium (HD-DVD-R) according to a second preferred embodiment of the present invention, in which an adhesive is used.

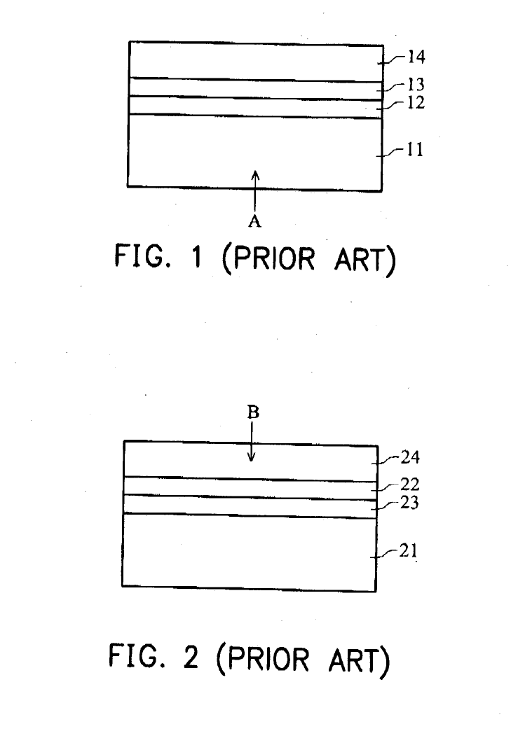

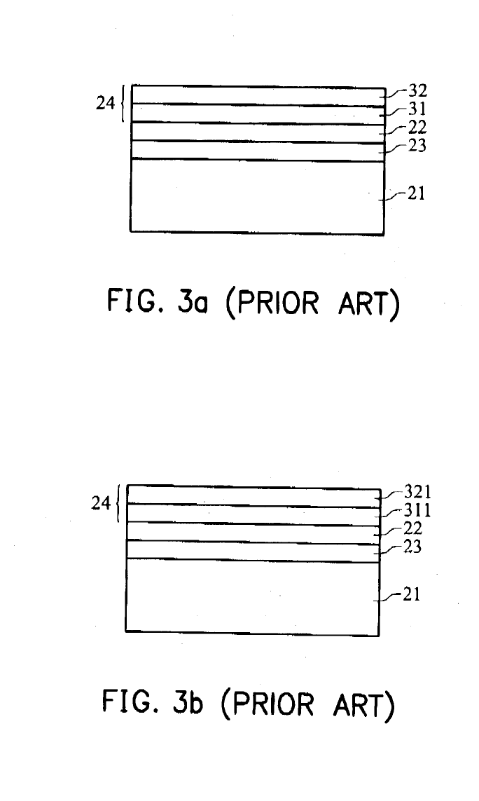

### DETAILED DESCRIPTION OF THE INVENTION

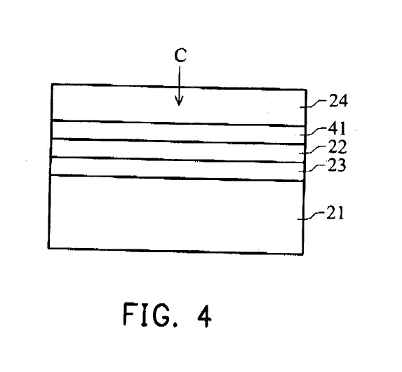

FIG. 4 is a cross-section of the high density write-once optical storage medium (HD-DVD-R) according to a first preferred embodiment of the present invention. Referring to FIG. 4, a reflective layer 23 is formed on a substrate 21 by sputtering. The reflective layer can be a reflective material such as silver, aluminum or silver alloy. Next, a dye recording layer 22 is formed on the reflective layer 23 by spin coating or vacuum deposition. Next, an inorganic material is sputtered on the dye recording layer 22 to form a protective layer 41. The inorganic material can be metal, metal oxide, metal nitride, carbon compound, or silicon compound, preferably an inorganic material highly transparent to blue laser. The protective layer 41 is disposed on the dye recording layer to prevent future direct contact between the dye recording layer and the cover layer. Next, a cover material is spin coated on the protective layer 41 to form a cover layer 24 having a thickness of 50 μm to 200 μm.

The HD-DVD-P medium of the present invention is applicable in an optical read and write system with blue laser having a wavelength in between 385 nm to 425 nm and an objective lens with numerical aperture (NA) greater than 0.8. The blue laser irradiates the optical storage medium from the surface of the cover layer 24 as depicted by the arrow C in FIG. 4.

In the present invention, since the protective layer 41 is formed before the cover layer 24, the undesired interaction between the cover layer 24 and the sensitive dye is effectively prevented. When the cover layer 24 is formed by spin coating, the dye recording layer 22 maintains the stability and the HD-DVD-R medium assures good quality.

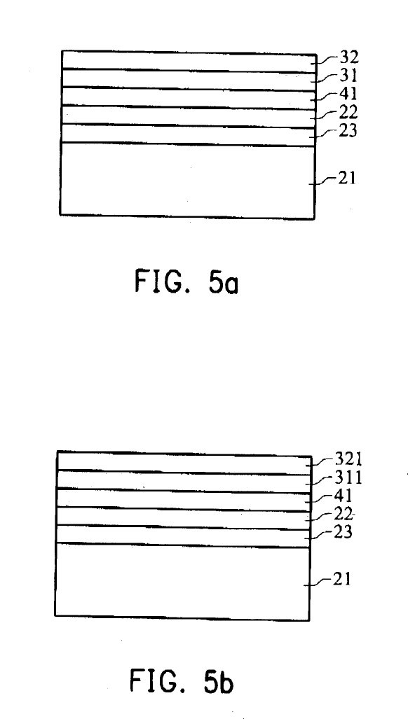

Moreover, an adhesive can be used when preparing HD-DVD-R medium. FIGS. 5a and 5b are cross-sections of the HD-DVD-R medium according to a second preferred embodiment of the present invention. Referring to FIG. 5a, after forming the protective layer 41, an adhesive agent is coated on the protective layer 41 to form an adhesive layer 31. Next, a transparent film 32 is adhered to the adhesive layer 31. Or, alternatively, referring to FIG. 5b, after forming the protective layer 41, a transparent film 321 already having an adhesive agent 311 thereon is adhered to the protective layer 41.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A write-once high density optical storage medium, applicable in an optical read or write system with blue laser having a wavelength in between 385 nm to 425 nm and an objective lens with numerical aperture (NA) greater than 0.8, the optical storage medium comprising:
a substrate;
a reflective layer disposed on the substrate;
a dye recording layer disposed on the reflective layer;
a protective layer disposed on the dye recording layer; and
a cover layer disposed on the protective layer, the cover layer having a thickness of 50 μm to 200 μm.

2. The optical storage medium as claimed in claim 1, wherein the reflective layer is formed by sputtering.

3. The optical storage medium as claimed in claim 1, wherein the dye recording layer is formed by spin coating.

4. The optical storage medium as claimed in claim 1, wherein the dye recording layer is formed by vacuum deposition.

5. The optical storage medium as claimed in claim 1, wherein the protective layer is formed by sputtering.

6. The optical storage medium as claimed in claim 1, wherein the cover layer is formed by spin coating.

7. The optical storage medium as claimed in claim 1, wherein the cover layer comprises an adhesive layer and a transparent film.

8. The optical storage medium as claimed in claim 1, wherein the protective layer comprises inorganic material transparent to blue laser.

9. The optical storage medium as claimed in claim 1, wherein the protective layer comprises metal, metal oxide, metal nitride, carbon compound, or silicon compound.

10. A write-once high density optical storage medium, applicable in an optical read or write system with blue laser having a wavelength in between 385 nm to 425 nm and an objective lens with numerical aperture (NA) greater than 0.8 the optical storage medium comprising:
a substrate;
a reflective layer disposed on the substrate;
a dye recording layer disposed on the reflective layer; and
a cover layer disposed on the dye recording layer, the cover layer having a thickness of 50 μm to 200 μm,
characterized in that the optical storage medium further includes a protective layer disposed between the dye recording layer and the cover layer.

11. The optical storage medium as claimed in claim 10, wherein the reflective layer is formed by sputtering.

12. The optical storage medium as claimed in claim 10, wherein the dye recording layer is formed by spin coating.

13. The optical storage medium as claimed in claim 10, wherein the dye recording layer is formed by vacuum deposition.

14. The optical storage medium as claimed in claim 10, wherein the protective layer is formed by sputtering.

15. The optical storage medium as claimed in claim 10, wherein the cover layer is formed by spin coating.

16. The optical storage medium as claimed in claim 10, wherein the cover layer comprises an adhesive layer and a transparent film.

17. The optical storage medium as claimed in claim 10, wherein the protective layer comprises inorganic material transparent to blue laser.

18. The optical storage medium as claimed in claim 10, wherein the protective layer comprises metal, metal oxide, metal nitride, carbon compound, or silicon compound.

19. A process for fabricating a write-once high density optical storage medium, comprising the following steps:
forming a reflective layer on a substrate by sputtering;
forming a dye recording layer on the reflective layer by spin coating or vacuum deposition;
forming a protective layer on the dye recording layer by sputtering; and
forming a cover layer on the protective layer.

20. The process as claimed in claim 19, wherein the cover layer is formed by spin coating or adhering.

21. The process as claimed in claim 19, wherein the cover layer has a thickness of 50 μm to 200 μm.

22. The process as claimed in claim 19, wherein the optical storage medium is applicable in an optical read or write system with blue laser having a wavelength in between 385 nm to 425 nm and an objective lens with numerical aperture (NA) greater than 0.8.

23. The process as claimed in claim 19, wherein the protective layer comprises inorganic material transparent to blue laser.
